(19) United States
(12) Patent Application Publication
(10) Pub. No.: US 2015/0044557 A1
(43) Pub. Date: Feb. 12, 2015

(54) NEGATIVE ELECTRODE ACTIVE MATERIAL FOR SODIUM-ION BATTERY, AND SODIUM-ION BATTERY

(71) Applicant: Toyota Jidosha Kabushiki Kaisha, Toyota-shi (JP)

(72) Inventor: Hideki Nakayama, Susono-shi Shizuoka-ken (JP)

(21) Appl. No.: 14/457,576

(22) Filed: Aug. 12, 2014

(30) Foreign Application Priority Data
Aug. 12, 2013 (JP) 2013-167419

(51) Int. Cl. H01M 4/60

(52) U.S. Cl. CPC H01M 4/60; H01M 2004/027
USPC 429/213; 546/5; 546/321

(57) ABSTRACT

A negative electrode active material for a sodium-ion battery includes a compound including an aromatic ring structure and two or more COOX groups in which X is Li or Na, and which are bonded to ends of the aromatic ring structure, the aromatic ring structure including an aromatic heterocyclic ring that contains nitrogen in the ring.

### INCORPORATION BY REFERENCE

The disclosure of Japanese Patent Application No. 2013-167419 filed on Aug. 12, 2013 including the specification, drawings and abstract is incorporated herein by reference in its entirety.

### BACKGROUND OF THE INVENTION

1. Field of the Invention

The invention relates to a negative electrode active material for a sodium-ion battery, which has high Na intercalation capacity.

2. Description of Related Art

Sodium-ion batteries are batteries in which sodium (Na) ions move between a positive electrode and a negative electrode. Sodium-ion batteries are advantageous in terms of being less costly than lithium (Li) ion batteries, since Na is more abundant than Li. Ordinarily, a sodium-ion battery includes a positive electrode active material layer that contains a positive electrode active material, a negative electrode active material layer that contains a negative electrode active material, and an electrolyte layer that is disposed between the positive electrode active material layer and the negative electrode active material layer.

Na₂C₈H₄O₄ is conventionally used as a negative electrode active material in sodium-ion batteries. For instance, Liang Zhao et al., “Disodium Terephthalate (Na₂C₈H₄O₄) as High Performance Anode Material for Low-Cost Room-Temperature Sodium-Ion Battery”, ADVANCED ENERGY MATERIALS, 2 (2012) 962-965 discloses a sodium-ion battery in which Na₂C₈H₄O₄ is used as a negative electrode active material. Although not a sodium-ion battery, M. Armand et al., “Conjugated dicarboxylate anodes for Li-ion batteries”, NATURE MATERIALS, VOL 8 (2009) 120-125 discloses a lithium-ion battery in which Li₂C₈H₄O₄ is used as a negative electrode active material. The same subject matter is described in related art according to Japanese Patent Application Publication No. 2012-221754 (JP 2012-221754).

There is a demand for a sodium-ion battery having high Na intercalation capacity.

### SUMMARY OF THE INVENTION

The invention provides a negative electrode active material for a sodium-ion battery, which has high Na intercalation capacity.

A first aspect of the invention relates to a negative electrode active material for a sodium-ion battery. The negative electrode active material includes a compound including an aromatic ring structure and two or more COOX groups in which X is Li or Na, and which are bonded to ends of the aromatic ring structure, the aromatic ring structure including an aromatic heterocyclic ring that contains nitrogen in the ring.

According to the first aspect of the invention, high Na intercalation capacity can be achieved, since the negative electrode active material includes the above aromatic ring structure.

A second aspect of the invention relates to a sodium-ion battery. The sodium-ion battery includes a positive electrode active material layer that contains a positive electrode active material; a negative electrode active material layer that contains a negative electrode active material; and an electrolyte layer disposed between the positive electrode active material layer and the negative electrode active material layer. The negative electrode active material of the sodium-ion battery is the negative electrode active material according to the first aspect of the invention.

According to the second aspect of the invention, high Na intercalation capacity can be achieved, since the negative electrode active material of the sodium-ion battery is the above-described negative electrode active material according to the first aspect of the invention.

According to the above aspects of the invention, it is possible to provide the negative electrode active material for a sodium-ion battery, which has high Na intercalation capacity.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic sectional diagram illustrating an example of a sodium-ion battery according to the invention;

FIG. 2 is a diagram illustrating charge and discharge results on a first example and a first comparative example;

FIG. 3 is a diagram illustrating charge and discharge results on a second example and a second comparative example; and

FIG. 4 is a diagram illustrating charge and discharge results on the second comparative example and a first reference example.

### DETAILED DESCRIPTION OF EMBODIMENTS

The invention relates to a negative electrode active material for a sodium-ion battery, and to a sodium-ion battery using the same. The negative electrode active material for a sodium-ion battery and the sodium-ion battery according to the invention will be explained in detail next.

A. Negative Electrode Active Material for a Sodium-Ion Battery

The negative electrode active material for a sodium-ion battery according to the invention will be explained first. The negative electrode active material for a sodium-ion battery according to the invention includes a compound that includes an aromatic ring structure and two or more COOX groups in which X is Li or Na, and which are bonded to the ends of the aromatic ring structure, the aromatic ring structure including an aromatic heterocyclic ring that contains nitrogen (N) in the ring.

According to the invention, high Na intercalation capacity can be achieved, due to the fact that the aromatic ring structure, to which the COOX groups are bonded, includes the aromatic heterocyclic ring that contains nitrogen (N) in the ring. Further, according to the invention, it is possible to significantly improve the negative electrode characteristic of a sodium-ion secondary battery, in terms of, for instance, increasing reversible capacity and charge and discharge efficiency, reducing charge and discharge overvoltage (improving the input-output characteristics), and achieving higher reaction potential (higher safety). The reasons why the feature of including the above aromatic ring structure elicits the effect of, for instance, increasing Na intercalation capacity are not clear, but the reasons are considered as follows. An organic material, which has a metal (for instance, X above) and an organic ligand (for instance, a COO group), such as the organic material that has the above two or more COOX groups, may be referred to as an organic Metal-Organic Framework (MOF) material, since the organic material has a structure in which organic framework layers having the organic ligand, and metal layers having the metal are arrayed regularly in a layered manner, i.e., a so-called MOF structure. In a case where the site having the organic ligand includes the structure having the conjugated π-electron cloud, it is deemed that the organic framework layer, which includes the structure having the conjugated π-electron cloud, functions as a redox site, while the metal layer functions as an Na ion storage site, so that charge and discharge, i.e., storage and release of energy, can be performed. In the invention, the negative electrode active material has the above aromatic ring structure as the structure having the conjugated π-electron cloud. Thus, the negative electrode active material has the conjugated π-electron cloud that is spread widely, and accordingly, electrons can be transferred smoothly. Further, the aromatic ring structure includes the aromatic heterocyclic ring, and, in consequence, has unshared electron pairs derived from N. Accordingly, it is considered that the balance of the conjugated π-electron cloud is lost as compared to an example in which the ring structure of the aromatic ring of the aromatic ring structure is formed of carbon alone, and as a result, electrons are transferred smoothly, and thus, it is possible to obtain the effect of, for example, increasing Na intercalation capacity.

The above compound included in the negative electrode active material for a sodium-ion battery according to the invention will be explained in detail next.

1. Compound

The compound according to the invention includes an aromatic ring structure and COOX groups.

The aromatic ring structure according to the invention includes an aromatic heterocyclic ring that contains nitrogen (N) in the ring.

The ring structure of the aromatic heterocyclic ring needs to exhibit aromaticity. The ring structure may be a five-membered ring exemplified by Formulas (1), (2) and (3), a six-membered ring exemplified by Formulas (4) and (5), a seven-membered ring or an eight-membered ring, but is preferably a six-membered ring, since high Na intercalation capacity can be achieved.

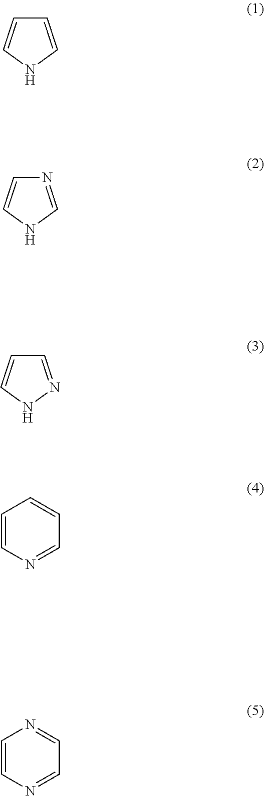 [SMILES: c1cc[nH]c1 ; c1c[nH]cn1 ; c1cn[nH]c1 ; c1ccncc1 ; c1cnccn1]

The number of N atoms that form the ring structure of the aromatic heterocyclic ring is not particularly limited, so long as it is equal to or greater than 1. For instance, the ring structures exemplified by Formulas (1) and (4) in which the number of N atoms is one, or the ring structures exemplified by Formulas (2), (3) and (5) in which the number of N atoms is two, can be used. Preferably, the number of N atoms in the invention is one, since high Na intercalation capacity can be achieved.

The number of aromatic heterocyclic rings in the aromatic ring structure is not particularly limited, so long as it is equal to or greater than 1, and the number of aromatic heterocyclic rings may be equal to or greater than 2. Preferably, the number of aromatic heterocyclic rings ranges from 1 to 3, and is preferably 1 in that range, i.e., the aromatic ring structure preferably has a single aromatic heterocyclic ring, since energy density can be increased in that case. If the number of aromatic heterocyclic rings is equal to or greater than 2, the aromatic ring structure may be a structure including the above aromatic heterocyclic rings bonded to each other via a single bond, as exemplified in Formulas (6) and (7) below, or may be a structure where aromatic heterocyclic rings are adjacent to each other, such as a condensed ring structure in which the aromatic heterocyclic rings are bonded to each other through condensation, as exemplified in Formulas (8) and (9) below, or may be a ring structure wherein the aromatic heterocyclic rings are bonded to each other via another aromatic ring.

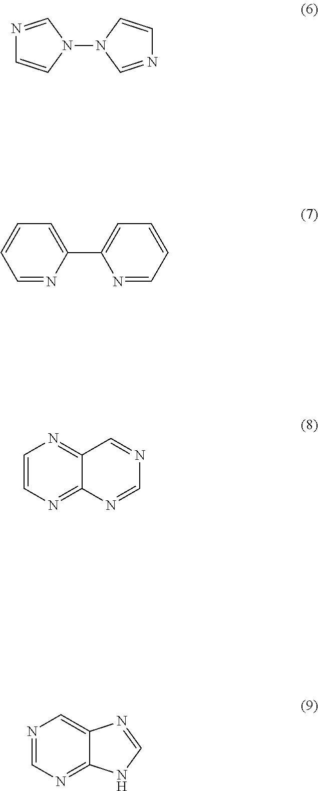 [SMILES: c1cn(-n2ccnc2)cn1 ; c1ccc(-c2ccccn2)nc1 ; c1cnc2ncncc2n1 ; c1ncc2nc[nH]c2n1]

The aromatic ring structure may include another aromatic ring in addition to the aromatic heterocyclic ring. The type of the other aromatic ring is not particularly limited, so long as the aromatic ring exhibits aromaticity. The other aromatic ring may be, for instance, an aromatic ring in which the elements that constitute the ring structure are carbon alone. The ring structure of the other aromatic ring is not particularly limited, so long as the ring exhibits aromaticity, and may be a five- or six-membered ring, or an eight-membered ring, but preferably a six-membered ring. The total number of aromatic rings in the aromatic ring structure is not particularly limited, so long as the aromatic ring structure includes at least one aromatic heterocyclic ring. The total number of aromatic rings may be equal to or greater than 2, but ranges preferably from 1 to 3, and is preferably 1 in that range, i.e., the aromatic ring structure preferably has a single aromatic heterocyclic ring, since higher energy density can be achieved. In a case where the aromatic ring structure includes two or more aromatic rings, the aromatic ring structure may have a polycyclic structure in which aromatic rings are bonded to each other via a single bond, or may have a condensed polycyclic structure in which aromatic rings are bonded to each other through condensation.

Specific examples of the aromatic ring structure include, for instance, the already-explained aromatic ring structures represented by Formulas (1) to (9), and also the aromatic ring structures represented by Formulas (10) to (16) below. In the invention, the aromatic ring structures represented by Formulas (1) to (5) can be preferably used, and, among the foregoing, the aromatic ring structures represented by Formulas (4) to (5) can be preferably used. Particularly preferably, the aromatic ring structure represented by Formula (4) is used herein, since high Na intercalation capacity can be achieved.

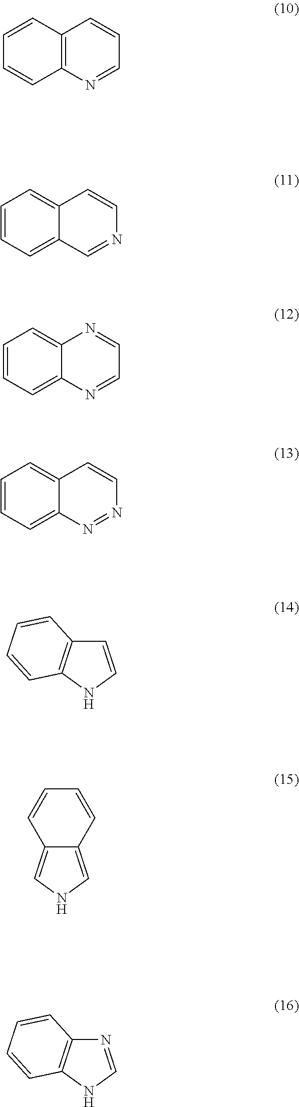

Two or more COOX groups in which X is Li or Na according to the invention are bonded to the above aromatic ring structure.

Either one of Li and Na may be used as X in the COOX group, but Na is preferred, since excellent charge and discharge efficiency can be achieved.

The number of COOX groups bonded to the aromatic ring structure is not particularly limited, so long as the number is equal to or greater than 2 and a stable MOF structure can be formed. For instance, the number of COOX groups ranges preferably from 2 to 4, and is preferably 2 within that range, since high Na intercalation capacity can be achieved.

The bonding sites, at which the COOX groups are bonded to the aromatic ring structure, are the ends of the aromatic ring structure. The feature that the COOX groups are bonded to the ends of the aromatic ring structure signifies that the COOX groups are bonded to carbon atoms that form the ring structure of the aromatic ring in the aromatic ring structure. The bonding sites are not particularly limited, so long as a stable MOF structure can be found, and each COOX group may be bonded to the aromatic heterocyclic ring in the aromatic ring structure, or may be bonded to the other aromatic ring. Preferably, at least one COOX group is bonded to the aromatic heterocyclic ring, more preferably, at least two COOX groups are bonded to the aromatic heterocyclic ring, and yet more preferably, all of the COOX groups are bonded to the aromatic heterocyclic ring, since high Na intercalation capacity can be achieved in such cases. When the number of COOX groups is two, the COOX groups are preferably bonded at diagonal positions in the aromatic ring structure, and are particularly preferably positioned in such a manner that the spacing between the bonding sites, at which the COOX groups are bonded, is greatest, since high Na intercalation capacity can be achieved. Herein, diagonal positions in the aromatic ring structure signify such positions that a line that joins the bonding sites extends only within the aromatic rings and on the single bond that joins aromatic rings to each other, in the aromatic ring structure. Specifically, in a case where the aromatic ring structure has only a six-membered aromatic heterocyclic ring such as a pyridine ring, and the number of COOX groups is two, the COOX groups are preferably bonded to the aromatic ring structure in such a manner that the COOX groups are at para positions.

Specific examples of the above compound include, for instance, the compounds represented by Formulas (17) to (21) below. Among the foregoing, compounds represented by Formulas (20) to (21) below can be preferably used, and the compound represented by Formula (20) can be particularly preferably used in the invention, since high Na intercalation capacity can be achieved.

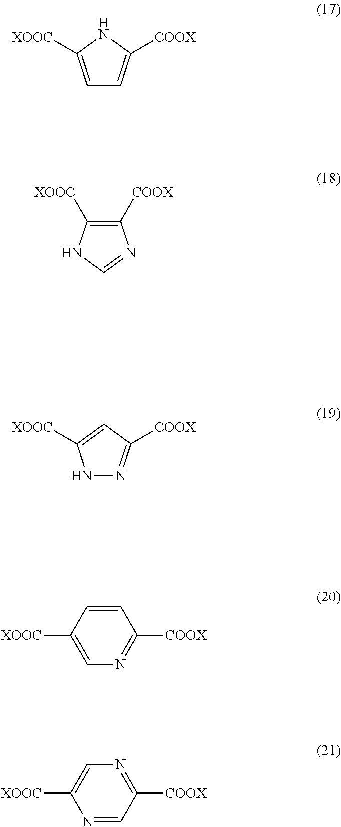

The method of producing the above compound is not particularly limited, so long as the above-described compound can be produced by the method, but the method may be for instance a method that includes neutralizing, with lithium hydroxide or sodium hydroxide, the compound having two or more carboxyl groups bonded to an aromatic ring structure. Specifically, the method may include stirring the compound having two or more carboxyl groups bonded to the aromatic ring structure, with lithium hydroxide or sodium hydroxide, in ethanol, followed by drying, for instance vacuum-drying.

2. Negative Electrode Active Material for a Sodium-Ion Battery

The negative electrode active material for a sodium-ion battery according to the invention includes the above compound, and is preferably composited with a conductive material, since the negative electrode active material for a sodium-ion battery, which has high Na deintercalation capacity, can be provided. The conductive material that is composited is not particularly limited, so long as it has a desired electron conductivity. Examples of the conductive material include carbon materials and metal materials, and carbon materials are preferable among the foregoing. Examples of the carbon materials include, specifically, carbon black such as acetylene black, Ketjen black, furnace black and thermal black; carbon fibers such as vapor grown carbon fibers (VGCFs); graphite; hard carbon; coke and the like. Examples of metal materials include iron (Fe), copper (Cu), nickel (Ni), aluminum (Al) and the like. The feature “the negative electrode active material for a sodium-ion battery and the conductive material are composited” signifies a state ordinarily obtained by subjecting the negative electrode active material for a sodium-ion battery and the conductive material to a mechanochemical treatment. Examples of that state include a state in which both materials are dispersed so as to be in close contact with each other, at the nanometer scale, and a state in which one of the materials is dispersed so as to be in close contact with the surface of the other material, at the nanometer scale. Chemical bonds may exist between the materials. Whether the materials are composited or not can be verified, for instance, by scanning electron microscope (SEM) observation, transmission electron microscope (TEM) observation, TEM-electron energy-loss spectroscopy (EELS) or X-ray absorption fine structure (XAFS). Examples of mechanochemical treatments include treatments that allow imparting mechanical energy, specifically, for instance, treatments using ball mills. A commercially available compositing device (for instance, Nobilta by Hosokawa Micron Corporation) or the like can be used herein.

In a case where the negative electrode active material for a sodium-ion battery is composited with the conductive material, the proportion of the composited conductive material ranges preferably from 1 wt % to 30 wt %, more preferably from 5 wt % to 20 wt %. That is because if the proportion of the composited conductive material is excessively small, the Na deintercalation capacity may not be sufficiently enhanced, whereas if the proportion of the composited conductive material is excessively large, the amount of active material decreases relatively, and capacity may drop. If the composited conductive material is a carbon material, the crystallinity of the carbon material is preferably high. Specifically, the carbon material is preferably composited in such a manner that an interlayer distance d002 or a D/G ratio is a predetermined value, as described below.

Preferably, the negative electrode active material for a sodium-ion battery according to the invention is for instance particulate. The average particle size (D₅₀) of the active material ranges for instance from 1 nm to 100 μm, and preferably from 10 nm to 30 μm.

B. Sodium-Ion Battery

The sodium-ion battery according to the invention will be explained next. The sodium-ion battery according to the invention includes a positive electrode active material layer that contains a positive electrode active material; a negative electrode active material layer that contains a negative electrode active material; and an electrolyte layer disposed between the positive electrode active material layer and the negative electrode active material layer. The negative electrode active material of the sodium-ion battery is the above-described negative electrode active material for a sodium-ion battery.

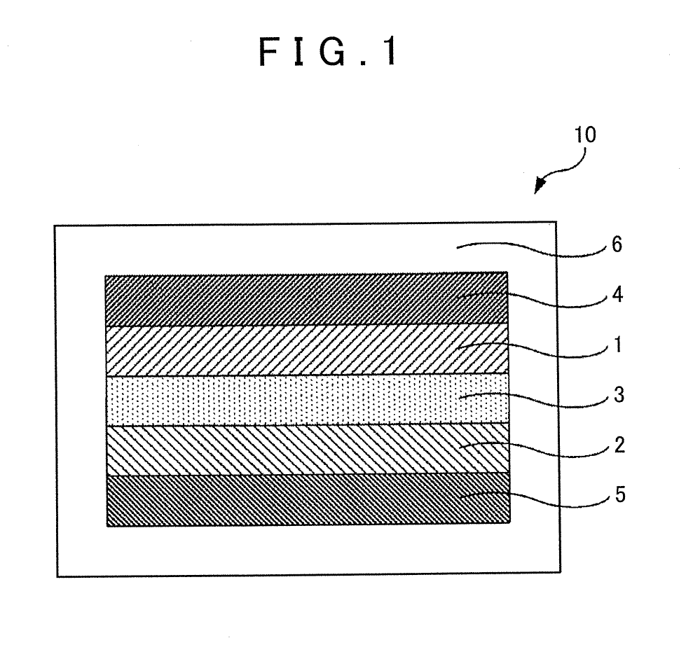

The sodium-ion battery according to the invention will be explained next with reference to accompanying drawings. FIG. 1 is a schematic sectional diagram illustrating an example of the sodium-ion battery according to the invention. A sodium-ion battery 10 illustrated in FIG. 1 includes a positive electrode active material layer 1, a negative electrode active material layer 2, an electrolyte layer 3 that is disposed between the positive electrode active material layer 1 and the negative electrode active material layer 2, a positive electrode collector 4 that collects current of the positive electrode active material layer 1, a negative electrode collector 5 that collects current of the negative electrode active material layer 2, and a battery case 6 that accommodates the foregoing members. A major feature of the sodium-ion battery according to the invention is that the negative electrode active material layer 2 contains the negative electrode active material described in the section “A. Negative electrode active material for a sodium-ion battery” above.

According to the invention, high Na intercalation capacity can be achieved, since the negative electrode active material is the above-described negative electrode active material for a sodium-ion battery.

According to the invention, the sodium-ion battery includes at least the negative electrode active material layer, the positive electrode active material layer and the electrolyte layer. The configuration of the sodium-ion battery according to the invention will be explained in detail next.

1. Negative Electrode Active Material Layer

The negative electrode active material layer according to the invention will be explained first. The negative electrode active material layer according to the invention contains at least a negative electrode active material. The negative electrode active material layer may contain, in addition to the negative electrode active material, at least one from among a conductive material, a binder and a solid electrolyte material.

The negative electrode active material according to the invention is ordinarily the negative electrode active material described in “A. Negative electrode active material for a sodium-ion battery” above.

The negative electrode active material layer according to the invention preferably contains a conductive material. The conductive material may be a conductive material that is composited with the negative electrode active material, or may be a material that is present, in the negative electrode active material layer, in a state of being not composited but mixed with the negative electrode active material, or may be both. The conductive material is not particularly limited, so long as it has a desired electron conductivity, and the particulars of the conductive material may be identical to those described in “A. Negative electrode active material for a sodium-ion battery” above. Among the foregoing, the conductive material is preferably a carbon material. Particularly preferably, the carbon material has high crystallinity. That is because Na ions are intercalated into the carbon material less readily, and the irreversible capacity due to Na ion intercalation can be reduced, when the crystallinity of the carbon material is high. The charge and discharge efficiency can be enhanced as a result. The crystallinity of the carbon material can be specified, for instance, by the interlayer distance d002 and the D/G ratio.

The interlayer distance d002 of the carbon material is preferably, for instance, equal to or lower than 3.5 Å, more preferably equal to or lower than 3.45 Å, and particularly preferably equal to or lower than 3.4 Å, since a highly crystalline carbon material can be achieved. The interlayer distance d002 is generally equal to or greater than 3.3 Å. The interlayer distance d002 signifies the interplanar spacing between (002) planes in the carbon material, and specifically corresponds to the distance between graphene layers. The interlayer distance d002 can be determined for instance on the basis of peaks obtained by X-ray diffraction (XRD) using CuKα rays.

The D/G ratio of the carbon material as obtained on the basis of Raman spectrometry is preferably, for instance, equal to or smaller than 0.80, and more preferably equal to or smaller than 0.6, more preferably, in particular, equal to or smaller than 0.4, and even yet more preferably equal to or smaller than 0.2, since a highly crystalline carbon material can be provided. The D/G ratio signifies the intensity of a D-band peak due to a defect structure, in the vicinity of 1350 cm⁻¹, with respect to the intensity of a G-band peak due to a graphite structure, in the vicinity of 1590 cm⁻¹, the D/G ratio being determined by Raman spectrometry (wavelength 532 nm).

The binder is not particularly limited, so long as it is chemically and electrically stable. Examples of the binder include fluorine-based binders such as polyvinylidene fluoride (PVDF) and polytetrafluoroethylene (PTFE), rubber-based binders such as styrene-butadiene rubber, olefin-based binders such as polypropylene (PP) and polyethylene (PE), and cellulose-based binders such as carboxymethyl cellulose (CMC). The solid electrolyte material is not particularly limited so long as it has a desired ion conductivity. Examples of the solid electrolyte material include oxide solid electrolyte materials and sulfide solid electrolyte materials. The solid electrolyte material will be explained in detail in the section “3. Electrolyte layer” below.

The content of the negative electrode active material in the negative electrode active material layer is preferably larger, in terms of capacity; for instance, the content ranges preferably from 60 wt % to 99 wt %, and particularly preferably from 70 wt % to 95 wt %. The content of the conductive material is preferably smaller, so long as the desired electron conductivity can be secured, and ranges for instance from 5 wt % to 80 wt %, and preferably from 10 wt % to 40 wt %. That is because if the content of conductive material is excessively small, sufficient electron conductivity may not be achieved, whereas if the content of the conductive material is excessively large, the amount of active material decreases relatively, and capacity may drop. The content of the binder is preferably smaller, so long as the negative electrode active material and so forth can be fixed stably, and the content of the binder ranges preferably, for instance, from 1 wt % to 40 wt %. That is because if the content of the binder is excessively small, sufficient binding properties may not be achieved, whereas if the content of the binder is excessively large, the amount of active material decreases relatively, and capacity may drop. The content of the solid electrolyte material is preferably smaller, so long as the desired ion conductivity can be secured, and the content of the solid electrolyte material ranges preferably, for instance, from 1 wt % to 40 wt %. That is because if the content of the solid electrolyte material is excessively small, sufficient ion conductivity may not be achieved, whereas if the content of the solid electrolyte material is excessively large, the amount of active material decreases relatively, and capacity may drop.

The thickness of the negative electrode active material layer varies significantly depending on the configuration of the battery, and ranges preferably, for instance, from 0.1 μm to 1000 μm.

2. Positive Electrode Active Material Layer

The positive electrode active material layer according to the invention will be explained next. The positive electrode active material layer according to the invention contains at least a positive electrode active material. The positive electrode active material layer may contain, in addition to the positive electrode active material, at least one from among a conductive material, a binder and a solid electrolyte material.

The positive electrode active material is not particularly limited, so long as it contains sodium and electrically allows sodium intercalation and deintercalation reactions to occur. Examples of the positive electrode active material include layered active materials, spinel-type active materials and olivine-type active materials. Specific examples of the positive electrode active material include NaFeO₂, NaNiO₂, NaCoO₂, NaMnO₂, NaVO₂, Na(Ni_{X}Mn_{1-X})O₂ (0<X<1), Na(Fe_{X}Mn_{1-X}) O₂ (0<X<1), NaVPO₄F, Na₂FePO₄F, Na₃V₂(PO₄)₃ and the like.

Preferably, the positive electrode active material is particulate. The average particle size (D₅₀) of the positive electrode active material ranges, for instance, from 1 nm to 100 μm, and preferably from 10 nm to 30 μm. The content of the positive electrode active material in the positive electrode active material layer is preferably larger, in terms of capacity; for instance, the content ranges preferably from 60 wt % to 99 wt %, and particularly preferably from 70 wt % to 95 wt %. The types and contents of the conductive material, binder and solid electrolyte material that are used in the positive electrode active material layer are identical to those of the negative electrode active material layer described above, and hence will not be explained again herein. The thickness of the positive electrode active material layer varies significantly depending on the configuration of the battery, and ranges preferably, for instance, from 0.1 μm to 1000 μm.

3. Electrolyte Layer

The electrolyte layer according to the invention will be explained next. The electrolyte layer according to the invention is disposed between the positive electrode active material layer and the negative electrode active material layer. Conduction of ions between the positive electrode active material and the negative electrode active material takes place via the electrolyte in the electrolyte layer. The form of the electrolyte layer is not particularly limited, and examples thereof include a liquid electrolyte layer, a gel electrolyte layer, a solid electrolyte layer and the like.

The liquid electrolyte layer is a layer ordinarily obtained using a nonaqueous electrolyte solution. The nonaqueous electrolyte solution contains ordinarily a sodium salt and a nonaqueous solvent. Examples of the sodium salt include inorganic sodium salts such as NaPF₆, NaBF₄, NaClO₄ and NaAsF₆, and organic sodium salts such as NaCF₃SO₃, NaN(CF₃SO₂)₂, NaN(C₂F₅SO₂)₂, NaN(FSO₂)₂ and NaC(CF₃SO₂)₃. The nonaqueous solvent is not particularly limited so long as it dissolves the sodium salt. Examples of high-dielectric-constant solvents include cyclic esters (cyclic carbonates) such as ethylene carbonate (EC), propylene carbonate (PC) and butylene carbonate (BC); and γ-butyrolactone, sulfolane, N-methyl pyrrolidone (NMP), 1,3-dimethyl-2-imidazolidinone (DMI) and the like. Low-viscosity solvents include chain esters (chain carbonates) such as dimethyl carbonate (DMC), diethyl carbonate (DEC) and ethyl methyl carbonate (EMC), acetates such as methyl acetate and ethyl acetate, and ethers such as 2-methyl tetrahydrofuran. A mixed solvent resulting from mixing a high-dielectric-constant solvent and a low-viscosity solvent may be used herein. The concentration of the sodium salt in the nonaqueous electrolyte solution ranges for instance from 0.3 mol/L to 5 mol/L, preferably from 0.8 mol/L to 1.5 mol/L. That is because if the concentration of sodium salt is excessively low, high-rate capacity may decrease, whereas if the concentration of the sodium salt is excessively high, viscosity increases, and low-temperature capacity may decrease. For instance, a low-volatile liquid such as an ionic liquid may be used as the nonaqueous electrolyte solution in the invention.

The gel electrolyte layer can be obtained, for instance, through gelling of a nonaqueous electrolyte solution by adding a polymer thereto. Specifically, gelling can be accomplished by adding, to a nonaqueous electrolyte solution, a polymer such as polyethylene oxide (PEO), polyacrylonitrile (PAN) or polymethyl methacrylate (PMMA).

The solid electrolyte layer is a layer obtained by using the solid electrolyte material. The solid electrolyte material is not particularly limited so long as it has a desired Na ion conductivity, but examples thereof include oxide solid electrolyte materials and sulfide solid electrolyte materials. Examples of oxide solid electrolyte materials include Na₃Zr₂Si₂PO₁₂, β alumina solid electrolytes (for example Na₂O-11Al₂O₃) and the like. Examples of sulfide solid electrolyte materials include Na₂S—P₂S₅ and the like.

The solid electrolyte material according to the invention may be amorphous or crystalline. Preferably, the solid electrolyte material is particulate. The average particle size (D₅₀) of the solid electrolyte material ranges, for instance, from 1 nm to 100 μm, and preferably from 10 nm to 30 μm.

The thickness of the electrolyte layer varies significantly depending on the type of the electrolyte and on the configuration of the battery, but ranges for instance from 0.1 μm to 1000 μm, and preferably from 0.1 μm to 300 μm.

4. Other Features

The sodium-ion battery according to the invention includes at least the above-described negative electrode active material layer, positive electrode active material layer and electrolyte layer. Ordinarily, the sodium-ion battery further includes a positive electrode collector that collects current of the positive electrode active material layer and a negative electrode collector that collects current of the negative electrode active material layer. Examples of the material of the positive electrode collector include stainless steel (SUS), aluminum, nickel, iron, titanium, carbon and the like. Examples of the material of the negative electrode collector include SUS, copper, nickel, carbon and the like. Each of the positive electrode collector and the negative electrode collector may be, for instance, in the form of a foil or a mesh, or may be porous.

The sodium-ion battery according to the invention may include a separator between the positive electrode active material layer and the negative electrode active material layer, since a battery that has yet higher safety can be obtained. Specific examples of the material of the separator include porous membranes of polyethylene (PE), polypropylene (PP), cellulose, polyvinylidene fluoride (PVDF) or the like, and nonwoven fabrics such as resin nonwoven fabrics and glass-fiber nonwoven fabrics. The separator may have a single-layer structure (for instance, of PE or PP) or a multilayer structure (for instance, PP/PE/PP). The battery case of an ordinary battery can be used herein as the battery case that is utilized in the invention. Examples of battery cases include battery cases made of SUS.

5. Sodium-Ion Battery

The sodium-ion battery according to the invention is not particularly limited so long as the battery includes the above-described positive electrode active material layer, negative electrode active material layer and electrolyte layer. The sodium-ion battery according to the invention may be a battery in which the electrolyte layer is a solid electrolyte layer, a battery in which the electrolyte layer is a liquid electrolyte layer, or a battery in which the electrolyte layer is a gel electrolyte layer. Further, the sodium-ion battery according to the invention may be a primary battery or a secondary battery, but is preferably a secondary battery among the foregoing, since a secondary battery can be charged and discharged repeatedly, and is thus useful for instance as an in-vehicle battery. The shape of the sodium-ion battery according to the invention may be, for instance, a coin shape, a laminate shape, a cylindrical shape or a square or rectangular shape. The method of producing the sodium-ion battery is not particularly limited, and may be the same as a production method for an ordinary sodium-ion battery.

The invention is not limited to the above embodiments. The foregoing embodiments are merely illustrative, and thus the technical scope of the invention encompasses any configuration that involves substantially the same features as those of the technical idea according to the invention and set forth in the claims, and that elicits substantially the same effect as that of the technical idea.

The invention will be explained more specifically based on the examples below.

### First Example

2,5-pyridinedicarboxylic acid, LiOH·H₂O and EtOH were placed into an eggplant flask, and stirring was performed under reflux. Thereafter, the whole was cooled to room temperature, was washed with EtOH, and was vacuum-dried at 140° C., to yield a Li-salt organic material having N introduced in the ring structure (negative electrode active material).

### Second Example

A Na-salt organic material having N introduced in the ring structure (negative electrode active material) was obtained in the same manner as in the first example, except that NaOH was used instead of LiOH·H₂O.

### First Comparative Example

A Li-salt organic material (negative electrode active material) was obtained in the same manner as in the first example, except that terephthalic acid was used instead of 2,5-pyridinedicarboxylic acid.

### Second Comparative Example

A Na-salt organic material (negative electrode active material) was obtained in the same manner as in the second example, except that terephthalic acid was used instead of 2,5-pyridinedicarboxylic acid.

### First Reference Example

The Na-salt organic material (negative electrode active material) synthesized in the second comparative example and a highly crystalline carbon material (VGCFs) were mixed at a weight ratio of 90%/10%. The resulting mixture was subjected to a ball-mill treatment for 24 hours at revolutions of 180 rpm, using ZrO₂ balls, to synthesize a material in which the organic material (negative electrode active material) and the carbon material were composited. The VGCFs used herein had an interlayer distance d002 of 3.37 Å and a Raman DIG ratio of 0.07.

(Production of a Battery for Evaluation)

A battery for evaluation using the obtained negative electrode active material was produced herein. Firstly, the obtained active material, a conductive material (acetylene black) and a binder (polyvinylidene fluoride (PVDF)) were mixed, at a weight ratio of the active material: the conductive material: the binder=85: 10: 5, and the mixture was kneaded, to yield a paste. Next, the obtained paste was applied onto a copper (Cu) foil, using a doctor blade, and the whole was dried and pressed, to yield a 20 μm-thick test electrode. In the first reference example, the composited negative electrode active material and carbon material were used as the active material described in this paragraph.

Thereafter, a CR2032-type coin cell was used, the above test electrode was used as a working electrode, metallic Na was used as a counter electrode, and a porous separator of polypropylene/polyethylene/polypropylene (thickness 25 μm) was used as a separator. A solution, which was obtained by dissolving NaPF₆, at a concentration of 1 mol/L, in a mixed solvent of equal volumes of ethylene carbonate (EC) and diethyl carbonate (DEC), was used as an electrolyte solution. A battery for evaluation was obtained as a result.

(Charge and Discharge Test)

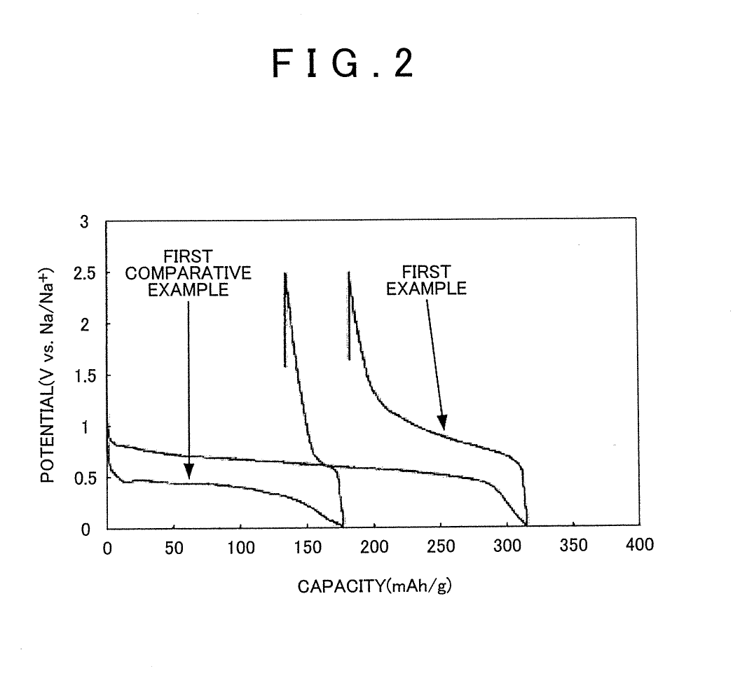

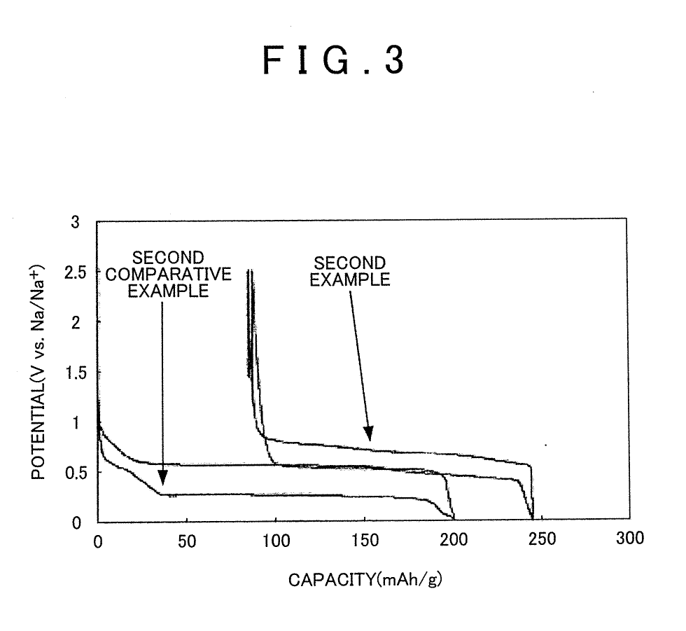

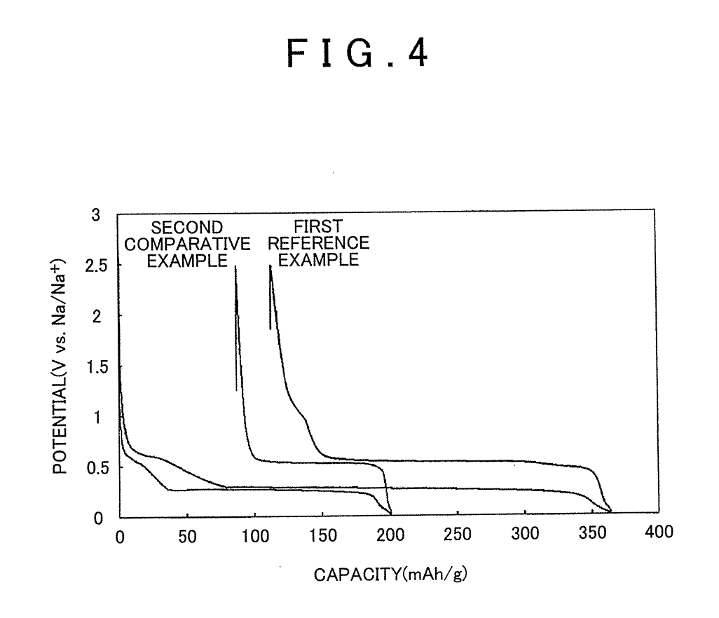

A charge and discharge test was performed on batteries for evaluation obtained in the examples and comparative examples. Specifically, the charge and discharge test was performed on each battery, at an environmental temperature of 25° C. and a C/50 current value (upper and lower limit voltages 2.5 V to 10 mV). The results are illustrated in FIG. 2, FIG. 3 and FIG. 4. Table 1 below indicates the results obtained on the basis of FIG. 2 to FIG. 4, that is, Na intercalation capacity, Na deintercalation capacity, charge and discharge efficiency and charge and discharge potential difference, of the batteries in which the materials were used. FIG. 2 is a diagram illustrating the charge and discharge results on the first example and the first comparative example. FIG. 3 is a diagram illustrating the charge and discharge results on the second example and the second comparative example. FIG. 4 is a diagram illustrating the charge and discharge results on the second comparative example and the first reference example. The theoretical capacity in a case where the reaction regarding the synthesized organic material and Na ions yields 2Na⁺ is 301 mAh/g (the first comparative example), 255 mAh/g (the second comparative example), 300 mAh/g (the first example) and 254 mAh/g (the second example).

TABLE 1

| | | | | | Charge | Charge and |
|---|---|---|---|---|---|---|
| | | | Na | Na | and | discharge |
| | | | intercalation | deintercalation | discharge | potential |
| | | End | capacity | capacity | efficiency | difference |
| | Structure | structure | (xNa) | (xNa) | (%) | (V) |
| First comparative example | 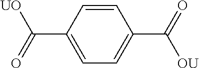 | —COOLi | 1.18 | 0.29 | 24.3 | 0.29 |
| Second comparative example | 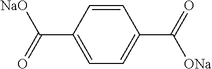 | —COONa | 1.58 | 0.89 | 56.5 | 0.27 |
| First example | 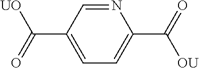 | —COOLi | 2.10 | 0.89 | 42.3 | 0.24 |
| Second example | 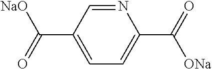 | —COONa | 1.93 | 1.26 | 65.3 | 0.13 |

FIG. 2 to FIG. 3 and Table 1 show that introducing N in the ring structure made it possible to enhance Na intercalation capacity and Na deintercalation capacity (reversible capacity), to enhance charge and discharge efficiency, to reduce charge and discharge overvoltage (to improve input-output characteristics), and to increase the reaction potential by about 0.3 V (to improve safety), and thus made it possible to significantly improve the negative electrode characteristics of the sodium(Na)-ion secondary battery, regardless of whether the ends are COOLi or COONa.

As FIG. 4 shows, the Na intercalation capacity (xNa) was 2.85 and the Na deintercalation capacity (xNa) was 1.96 in the first reference example. The charge and discharge efficiency (%) was 68.8. The second comparative example and the first reference example revealed that the reversible capacity (the second comparative example: 113 mAh/g, 0.89Na⁺ the first reference example: 250 mAh/g, 1.96Na⁺) and the charge and discharge efficiency (the second comparative example: 56.5% →the first reference example: 68.8%) improved significantly by compositing a highly crystalline carbon material with the organic material of the second comparative example (theoretical capacity=255 mAh/g at the time of the 2Na⁺ reaction).

(X-ray Diffractometry)

The active material powders of the first comparative example and the second comparative example were subjected to powder X-ray diffractometry. The measurements were performed using an X-ray diffractometer (RINT 2200 manufactured by Rigaku Corporation), with CuKα rays (wavelength 1.54051 Å) as radiant rays. In the measurements that were performed, a graphite single-crystal monochromator was used to render X-rays monochromatic, the applied voltage was set to 40 kV, the current was set to 30 mA, and the angle range was set to 2 θ=10° to 90° at a scanning rate of 4°/minute. The results revealed that the first comparative example had a crystalline structure attributable to the space group P2₁/c, and the second comparative example had a crystalline structure attributable to the space group Pbc2₁.

What is claimed is:

1. A negative electrode active material for a sodium-ion battery, comprising
a compound including an aromatic ring structure and two or more COOX groups in which X is Li or Na, and which are bonded to ends of the aromatic ring structure, the aromatic ring structure including an aromatic heterocyclic ring that contains nitrogen in the ring.

2. A sodium-ion battery comprising:
a positive electrode active material layer that contains a positive electrode active material;
a negative electrode active material layer that contains a negative electrode active material; and
an electrolyte layer disposed between the positive electrode active material layer and the negative electrode active material layer, wherein
the negative electrode active material of the sodium-ion battery is the negative electrode active material according to claim 1.
